(19) United States
(12) Patent Application Publication
(10) Pub. No.: US 2008/0284335 A1
(43) Pub. Date: Nov. 20, 2008

(54) DISCHARGE LAMP

(75) Inventors: Richard May, San Diego, CA (US); James Randall Cooper, San Diego, CA (US)

Correspondence Address: KNOBBE MARTENS OLSON & BEAR LLP, 2040 MAIN STREET, FOURTEENTH FLOOR, IRVINE, CA, 92614, US

(73) Assignee: Ultraviolet Sciences, Inc., San Diego, CA (US)

(21) Appl. No.: 12/121,662

(22) Filed: May 15, 2008

Related U.S. Application Data
(60) Provisional application No. 60/930,597, filed on May 16, 2007.

(51) Int. Cl. H01J 61/067; H01J 9/02

(52) U.S. Cl. 313/607; 445/52

(57) ABSTRACT

A discharge device for operation in a gas at a prescribed pressure includes cathode that is at least partially enclosed by a dielectric layer. The dielectric layer is at least partially enclosed by an anode. The dielectric and the anode have one or more aligned penetrations therein. The cathode may be hollow to allow a cooling fluid to circulate inside the cathode to cool the lamp.

### RELATED APPLICATIONS

This application claims priority to U.S. Provisional Application No. 60/930,597, filed on May 16, 2007, which is incorporated by reference in its entirety.

### FEDERALLY SPONSORED RESEARCH

The work described herein was performed pursuant to Air Force Office of Scientific Research contract FA9550-05-C-0033. The Government may have some rights in this invention.

### TECHNICAL FIELD

This invention relates generally to gas discharge light sources and the applications of those devices, including the production of ultra-pure water such as used in semiconductor processing. This invention also relates to an excimer gas discharge light source for producing high intensity ultraviolet (UV) and vacuum UV light. This invention includes design improvements to cathode boundary layer (CBL) discharge and micro-hollow cathode discharge (MHCD) light sources.

### BACKGROUND

Volatile organic compounds and other organic chemicals are widely used as solvents, degreasers, coolants, gasoline additives, and raw materials for other synthetic organic chemicals. These organic compounds are commonly found as trace contaminants in municipal and natural water streams. As a group, they are referred to as total oxidizable carbons (TOC). These compounds are very difficult to remove by conventional means, such as filtration and absorption by media such as activated carbon.

A number of methods have been developed to remove TOC from water for applications requiring ultra-pure water. These methods physically separate the TOC from the water, chemically bind them so they are removed from the water, or chemically break them down into harmless components.

Exposure to ultraviolet light is one known method of removing TOC from water in ultra-pure water systems. The ultraviolet light for TOC removal in current commercially available systems is produced by low-pressure mercury vapor lamps operating at the 185 nm wavelength. There also exist systems using pulsed light sources that produce broad spectrum light below 250 nm. These pulsed light sources are typically xenon flashlamps. Excited dimer (“excimer”) pulsed discharge lamps have also been employed for removing TOC.

More recently, excimer lamps based on cathode boundary layer discharge have been proposed as UV light sources for water purification and other applications. Various embodiments of these devices are described in U.S. Patent publication 2004/0144733.

FIGS. 1A and 1B show a prior art cathode boundary layer (CBL) discharge light source 101. Light source 101 has a planar anode 116 on top of a dielectric layer 114, which is on top of a cathode 112. The anode 116 and dielectric layer 114 each have an aligned opening or penetration to the cathode 112. The assembly is placed in transparent enclosure filled with an appropriate excimer gas such as Xenon. When a voltage is applied between the anode and cathode, a stable UV producing discharge is formed in the openings. In some embodiments, small holes or hollows are formed through or partially into the cathode surface in the opening. These lamps are referred to as micro-hollow cathode discharge (MHCD) light sources. The physics behind these lamps is well understood, and is described further in the above mentioned U.S. Patent Publication.

These light sources have been studied for a number of years. However, many of these devices have disadvantages because of their materials of construction, thermal design, manufacturability, and other considerations. For example, light source 101 is rectangular, with approximately uni-directional light output. Although Patent Publication 2004/0144733 proposes a cylindrical design that outputs light radially inward, this configuration is also not optimal for manufacturability, efficiency, or long life. It would be desirable to develop a design which overcomes some of these difficulties and makes it possible to use these CBL and MHCD light sources in commercial applications.

### SUMMARY

One embodiment is a gas discharge lamp comprising a first electrode, a dielectric layer enclosing at least a portion of an outer circumferential surface area of the first electrode, a second electrode enclosing at least a portion of an outer circumferential surface of the dielectric layer, and one or more penetrations through the dielectric layer and the second electrode.

In another embodiment, there is a method of making a gas discharge lamp, said method comprising enclosing an outer surface of an axially extending conductor with a fenestrated sleeve, and enclosing the outer surface of the sleeve with a fenestrated conductor.

In another embodiment, there is a UV gas discharge light source comprising a center conductor, an insulating sleeve enclosing an outer portion of the center conductor, wherein the sleeve comprises a sleeve penetration forming an uncovered outer portion of the center conductor, and an outer conductor enclosing an outer portion of the sleeve, wherein the outer conductor comprises an outer conductor penetration forming an uncovered outer portion of the center conductor.

In another embodiment, there is a fluid treatment system comprising a treatment chamber, a fluid inlet configured to input fluid into the treatment chamber, a fluid outlet configured to output fluid from the treatment chamber, and a discharge lamp coupled to the treatment chamber, the discharge lamp comprising a first electrode, a dielectric layer enclosing at least a portion of an outer circumferential surface area of the first electrode, a second electrode enclosing at least a portion of an outer circumferential surface of the dielectric layer, and one or more penetrations through the dielectric layer and the second electrode.

### BRIEF DESCRIPTION OF DRAWINGS

FIGS. 1A and 1B depict perspective and cross sectional views of a prior art discharge light source.

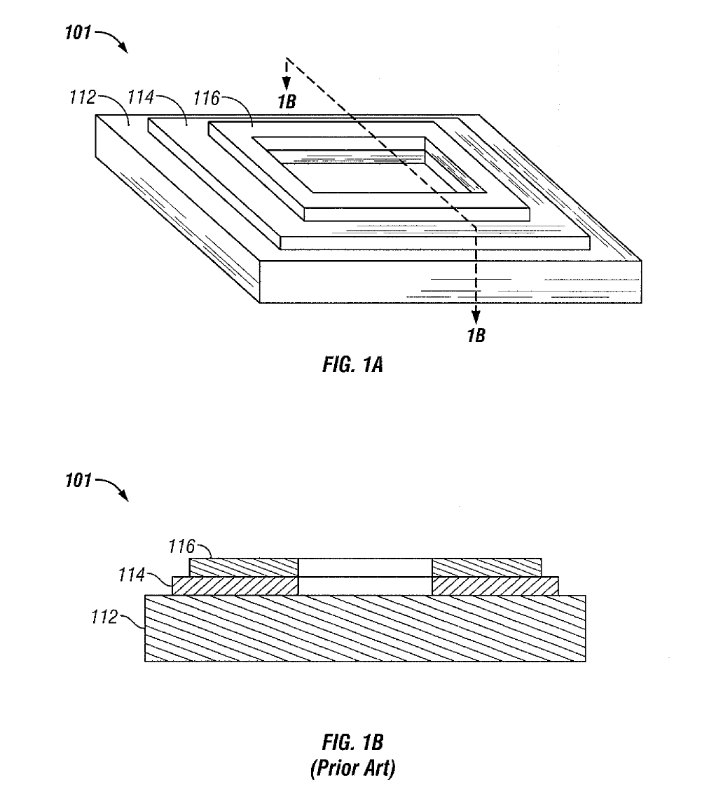

FIG. 2 depicts exploded perspective and assembled perspective views of one embodiment of a light source.

FIG. 3 depicts exploded perspective and assembled perspective views of another embodiment of a light source.

FIG. 4 depicts a cross sectional view of a fluid treatment apparatus containing light sources of FIG. 3.

### DETAILED DESCRIPTION

The following detailed description is directed to certain specific embodiments of the invention. However, the invention can be embodied in a multitude of different ways as defined and covered by the claims. In this description, reference is made to the drawings wherein like parts are designated with like numerals throughout.

In one embodiment, a light source contains a dielectric sleeve covering an axially extending center electrode, and a second outer electrode covering the sleeve. Both the sleeve and the outer electrode include penetrations for forming a UV light generating cathode fall discharge. The light source can be used to create a purified fluid from an initially unpurified fluid surrounding the light source. In one embodiment, this light source is cylindrically shaped. As a result, light can be more easily transmitted into a volume of fluid being purified.

In some embodiments, the center electrode is hollow. A hollow center electrode allows a cooling fluid, such as water, to pass through the center electrode to cool the light source to prevent overheating and extend the life of the lamp.

The UV lamps described in this application are useful in a variety of applications where UV illumination is desirable such as water or other purification/disinfection systems, curing systems, and the like.

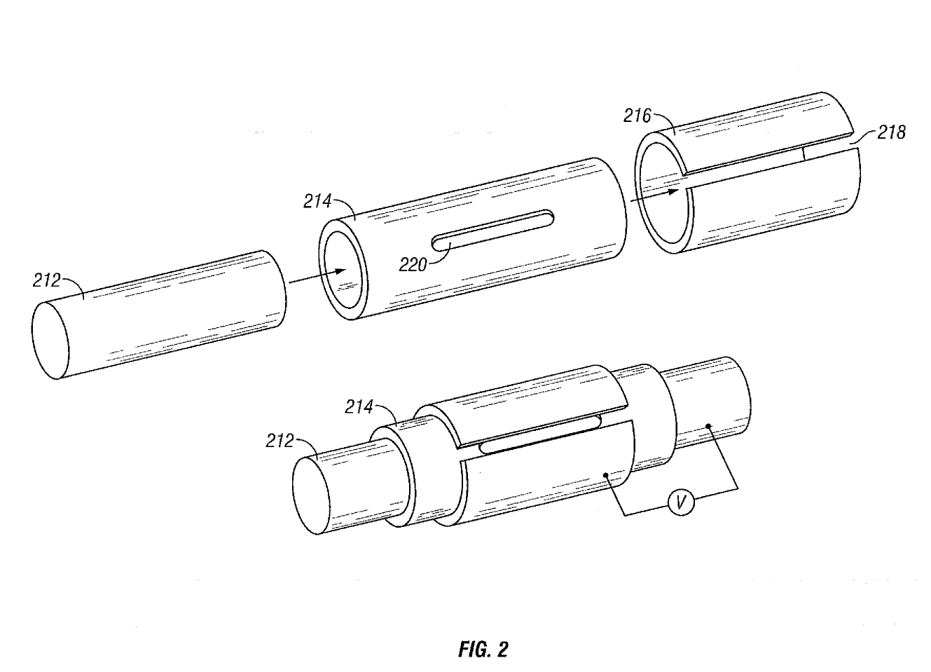

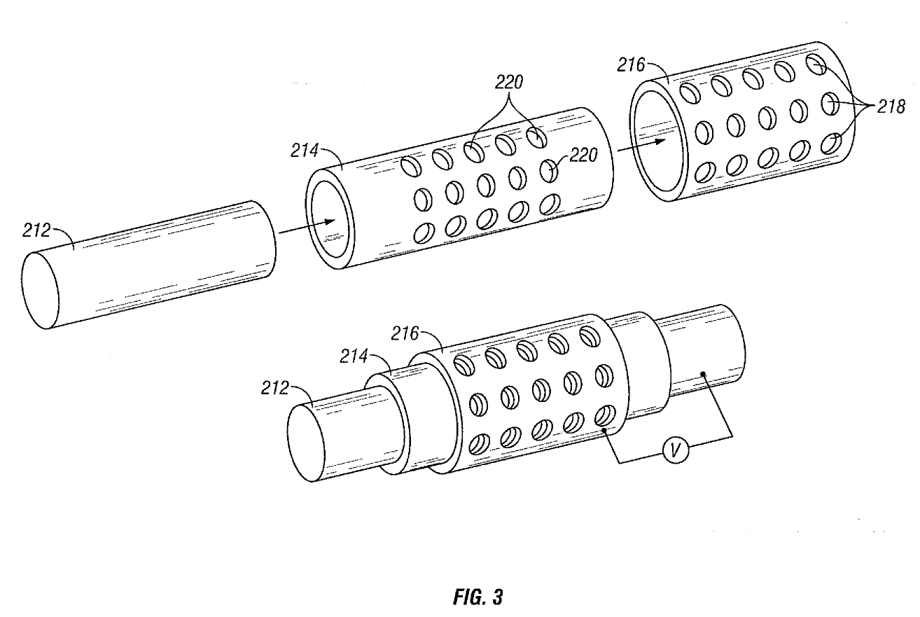

FIGS. 2-3 show designs for light sources 201, 301 or a UV gas discharge lamp, comprising penetrations. In one embodiment, the light source is a CBL discharge and/or MHCD light source.

Referring now to FIGS. 2 and 3, the design has an axially extending center conductor 212 forming a first electrode which can be solid or a tube. The length and diameter of the center conductor is not particularly limited. The first electrode will generally form the cathode of the light source. A substantially circular cross section for electrode 212 has been found suitable, but oval, or other cross sectional shapes are possible. A substantially cylindrical electrode includes closed curvilinear geometric shapes with cross sections that are round, oval, ellipse, square, etc. Broadly speaking, substantially cylindrically shaped means shaped as an elongated axially extending prism having a contiguous outer surface contour defined by the geometric shape of the cross section. It will be appreciated that closed geometric solid shapes with contiguous outer surfaces that do not have elongated shapes may also be utilized.

The center conductor 212 is typically metal, but may be formed from any good conductor or semiconductor. The surface of this center conductor 212 may be smooth, or it may be intentionally created with one or more “micro-hollows” (not shown) which are small depressions or holes on the outer surface with typical diameters ranging from 10 micrometers to several hundred micrometers. These holes may be blind holes, or they may extend through the wall if the center conductor is a tube.

In FIGS. 2 and 3, at least partially enclosing the outside surface of the center conductor is a dielectric layer 214. “Enclosing” as used here means placed over a contiguous surface that extends in more than two dimensions, e.g. bending along a curved surface or extending over a corner. Preferably, the dielectric layer fully surrounds an outer surface segment of the center conductor, covering all sides of the covered length except for the openings described further below. The dielectric layer 214 may advantageously be formed as a sleeve that covers at least a portion of an outer circumferential surface area of the first electrode 212. The dielectric material 214 is typically a ceramic or plastic, but can be any insulator. It is generally advantageous if the dielectric strength is greater than about 10 kV/cm. The dielectric could also be a high impedance conductor, but the impedance or electrical resistance should be high enough to limit the electrical current through it to practical values. This dielectric layer 214 may be formed on the center conductor by deposition or another suitable process, or pressed over the center conductor as an independent part. The cross sectional shape of this dielectric layer 214 is preferably substantially the same as the inner conductor (e.g., cylindrical), with the inner diameter roughly matching the outer diameter of the center conductor 212. The surfaces of the dielectric layer 214 may be flat or may have grooves, slots, or other features to expedite de-gassing of the device. Some spaces between the outer surface of the conductor and the dielectric material may be provided. For example, if the center conductor has a circular cross section, the dielectric sleeve may have an n-sided polygon cross section where n=16. This will produce spaces between the outer surface of the conductor and the inner surface of the dielectric sleeve at the vertices of the polygon.

Further, FIGS. 2 and 3 illustrate that at least partially enclosing the dielectric layer 214 is an outer conductor 216 or second electrode, which is substantially a tube again having substantially the same cross sectional shape as the inner conductor and the dielectric. The second electrode 216 will generally form the anode. The second electrode 216 encloses at least a portion of an outer circumferential surface of the dielectric layer 214. The outer conductor 216 is typically metal, but may be formed from any good conductor or semiconductor.

In some embodiments, the dielectric layer 214 may advantageously be axially longer than the outer conductor 216. The outer conductor 216 is preferably positioned such that there is a proper level of resistive insulation supplied by the dielectric layer 214 to prevent an electrical breakdown from a creepage path between the two conductors 212, 216.

There are one or more aligned penetrations 218, 220 or fenestrations through the outer conductor 216 and the dielectric layer 214, exposing the center conductor 212. Penetrations are “aligned” when a portion of the surface of the center conductor is exposed through the penetrations in the dielectric and the outer conductor. Exact correspondence between the edges of the penetrations is not required. The entire structure is immersed in a gas or gas mixture inside a UV transmissive envelope which is capable of producing excited dimers in the gas. Examples of such “excimers” are Xe₂, XeCl, KrCl, KrF, and ArF. The size of these penetrations 218, 220 preferably is such that the pressure of the gas or gas mixture multiplied by the smallest dimension of the penetration is in the range 0.1-5000 Torr-cm. For example, the smallest dimension might be 100 micrometers, and the lamp may operate at 5 atmospheres pressure (3800 Torr), so that the P*d product is 38 Torr-cm. The size of the penetrations in FIGS. 2 and 3 are for illustration only and are not necessarily to scale for a lamp.

In FIG. 2, the penetration 218 in the outer conductor 216 is a slot extending the entire length of the outer conductor. Penetration 220 in the dielectric 214 is a slot of the same or about the same width as the slot in the outer conductor 216, but which ends without reaching the edges of the dielectric layer 214 and has an axial extent less than the axial extent of the outer conductor 216. As shown in this figure, the penetrations 218, 220 in the dielectric 214 and the outer conductor 216 are substantially aligned. It will be appreciated that multiple slots could be provided. Additionally, if there are one or more microhollows (which are optional) in either or both electrodes, the smallest dimension of these microhollows typically has a diameter ranging from 10 micrometers to several hundred micrometers, although in some embodiments it may be possible to use different sizes than this.

FIG. 3 illustrates an embodiment where the penetrations are formed as holes rather than slots. A wide variety of penetration configurations are possible. Although sown as a straight cylinder in FIGS. 2 and 3, the lamp could be formed with a curved or bent central axis.

Some preferred embodiments of the invention have a cylindrical metal cathode, a tubular ceramic dielectric layer on top of the cathode, and a tubular metal anode outside the dielectric. The anode and dielectric have penetrations which are slots or circular holes with dimensions as described above. The materials are chosen for their machinability, resistance to corrosion by discharges and excimer gases, and for the ability to survive at temperatures above 300-400° C. for greater than 30 minutes such that the entire structure can be cleaned by baking it out at high temperatures. The entire structure is incorporated into a sealed transmissive envelope which contains the excimer gas and transmits the light generated by the device.

The device may also incorporate a layer on the outer surface of the anode 216 which reflects impinging or reflected excimer radiation away from the device. Another added feature may be a hollow tubular center conductor 212 which allows for cooling the device by convection or forced gas or liquid cooling through the tube.

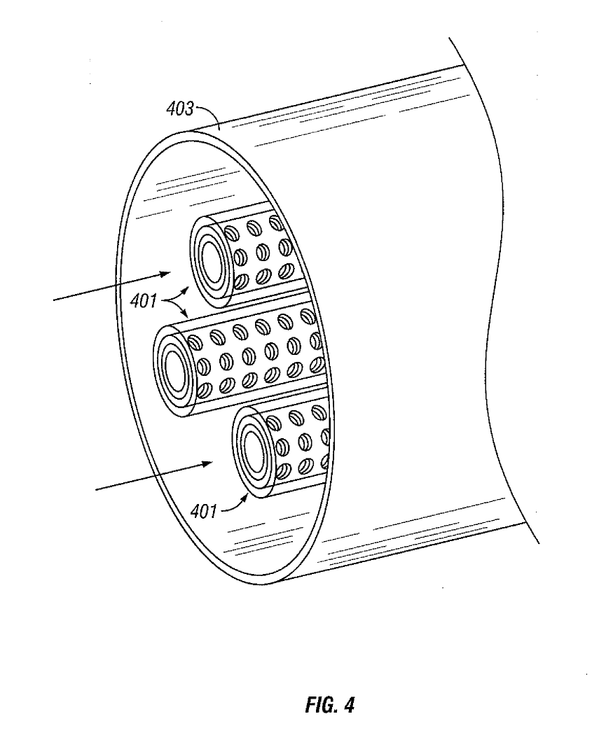

FIG. 4 shows a perspective view of a fluid treatment system 400 or apparatus comprising multiple light sources 401 that emit UV light into a treatment chamber 403. It will be appreciated that 1, 2, 3, or more than three lamps could be provided in such a treatment chamber. Light sources 401 can have a first electrode, dielectric layer, and second electrode, as illustrated in FIGS. 2 and 3. As described above the light sources 401 are surrounded by a UV transmissive envelope 402, The fluid can surround all portions of the glass envelope as the fluid passes through a treatment chamber 403. A treatment chamber can have a fluid inlet and outlet (not shown) for inputting contaminated fluid into and outputting purified fluid out of the treatment chamber 403, respectively. Light sources 401 can remove contaminants from a fluid being purified, such as water. The lamp design described above provides efficient UV exposure to the fluid as it passes over the lamps.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A gas discharge lamp comprising:
a first electrode;
a dielectric layer enclosing at least a portion of the outer surface area of the first electrode;
a second electrode enclosing at least a portion of an outer surface area of the dielectric layer; and
one or more penetrations through the dielectric layer and the second electrode.

2. The lamp of claim 1, wherein the second electrode penetration is larger than the dielectric layer penetration.

3. The lamp of claim 1, wherein the first electrode is substantially cylindrical.

4. The lamp of claim 1, wherein the penetrations comprise at least one of a slot and hole.

5. The lamp of claim 4, wherein the penetrations are aligned.

6. The lamp of claim 1, wherein the first electrode comprises a cathode and the second electrode comprises an anode.

7. A method of making a gas discharge lamp, said method comprising:
enclosing an outer surface of a first conductor with a fenestrated sleeve; and
enclosing an outer surface of the sleeve with a fenestrated conductor.

8. The method of claim 7, wherein at least one of the conductors or the sleeve is substantially cylindrical.

9. The method of claim 7, wherein the fenestrations comprise at least one of a slot and hole.

10. The method of claim 7, wherein the first conductor is hollow.

11. The method of claim 10, wherein the hollow portion of the first conductor contains a cooling fluid.

12. The method of claim 7, wherein the conductors comprise metal.

13. The method of claim 7, wherein the sleeve comprises dielectric.

14. The method of claim 13, wherein the sleeve comprises ceramic.

15. A UV gas discharge light source comprising:
a center conductor configured to discharge UV light;
an insulating sleeve enclosing an outer portion of the center conductor, wherein the sleeve comprises a sleeve penetration forming an uncovered outer portion of the center conductor; and
an outer conductor enclosing outer portion of the sleeve, wherein the outer conductor comprises an outer conductor penetration forming an uncovered outer portion of the center conductor.

16. A fluid treatment system comprising:
a treatment chamber;
a fluid inlet configured to input fluid into the treatment chamber;
a fluid outlet configured to output fluid from the treatment chamber; and
a discharge lamp coupled to the treatment chamber, the discharge lamp comprising:
a first electrode;
a dielectric layer enclosing at least a portion of the outer surface area of the first electrode;
a second electrode enclosing at least a portion of an outer surface of the dielectric layer; and
one or more aligned penetrations through the dielectric layer and the second electrode.

17. The fluid treatment system of claim 16, wherein the discharge lamp emits UV light into the treatment chamber.

18. The fluid treatment system of claim 16, wherein the fluid comprises water.
